(19) United States
(12) Patent Application Publication
(10) Pub. No.: US 2026/0056678 A1
(43) Pub. Date: Feb. 26, 2026

(54) METHOD AND APPARATUS FOR CONFIGURING DATA REPLICAS FOR MULTIPLE MACHINE ROOMS, MEDIUM, DEVICE AND PRODUCT

(71) Applicant: Beijing Volcano Engine Technology Co., Ltd., Beijing (CN)

(72) Inventors: Zuzhi Chen, Beijing (CN); Binbin Chen, Beijing (CN); Xinchun Zhang, Beijing (CN); Wei Zhang, Beijing (CN); Bo Zhao, Beijing (CN); Tieying Zhang, Los Angeles, CA (US); Yakun Li, Beijing (CN); Yong Tian, Beijing (CN); Wei Feng, Beijing (CN); Kang Zhang, Beijing (CN); Jianjun Chen, Los Angeles, CA (US); Rui Shi, Beijing (CN)

(21) Appl. No.: 19/246,556

(22) Filed: Jun. 23, 2025

(30) Foreign Application Priority Data
Aug. 26, 2024 (CN) 202411179733.6

(51) Int. Cl. G06F 3/06

(52) U.S. Cl. CPC G06F 3/065; G06F 3/0614; G06F 3/067

(57) ABSTRACT

A method and apparatus for configuring data replicas for multiple machine rooms, a medium, a device and a product. The method includes: acquiring meta information of a file directory and historical traffic information for the file directory, generating a plurality of replica adjustment strategies as alternatives based on a deployment of data replicas of the file directory in multiple machine rooms in the meta information of the file directory, predicting, based on the meta information and the historical traffic information, a potential benefit of executing each of the plurality of replica adjustment strategies, selecting a target replica adjustment strategy from the plurality of replica adjustment strategies based on the potential benefit corresponding to each of the plurality of replica adjustment strategies, and controlling, based on the target replica adjustment strategy, a deployment of data replicas corresponding to the file directory in the multiple machine rooms.

### CROSS-REFERENCE TO RELATED APPLICATION

The present application claims priority to Chinese Patent Application No. 202411179733.6, filed on Aug. 26, 2024, and the disclosure of the above patent application is incorporated herein by reference in its entirety as part of the present disclosure.

### TECHNICAL FIELD

The present disclosure relates to the field of computer technologies and, in particular, to a method and apparatus for configuring data replicas for multiple machine rooms, a medium, a device and a product.

### BACKGROUND

With the rapid growth of data volume and the increasing demand for distributed computing, distributed file systems (HDFS) have become one of the infrastructures for large-scale data storage and processing. Distributed file systems have high availability, high fault tolerance and high performance through data sharding and deployment of multiple machine rooms.

Generally, in a distributed file system deployed for multiple machine rooms, data is configured in different machine rooms in the form of multiple data replicas. Therefore, in the distributed file system with multiple machine rooms, how to deploy data replicas for the multiple machine rooms has a very significant impact on costs.

In the related art, generally, an operator manually adjusts data replicas of individual file directories in a distributed file system based on access patterns and traffic analysis of data, to optimize the performance and cost of the distributed file system. For example, the number of data replicas of hot data may be increased, the number of data replicas of cold data may be reduced, or a file directory may be copied to a machine room with intensive access of computing tasks. However, this manner of manually adjusting the deployment of data replicas has low adjustment efficiency and poor adjustment effects.

### SUMMARY

The Summary is provided to introduce the concepts in a brief form, and these concepts will be described in detail in the section of Detailed Description below. The Summary is not intended to identify key features or essential features of the claimed technical solutions, nor is it intended to be used to limit the scope of the claimed technical solutions.

In a first aspect, the present disclosure provides a method for configuring data replicas for multiple machine rooms, including:
acquiring meta information of a file directory historically accessed by each of multiple machine rooms and historical traffic information for the file directory;
generating a plurality of replica adjustment strategies as alternatives based on a deployment of data replicas of the file directory in the multiple machine rooms in the meta information of the file directory;
predicting, based on the meta information and the historical traffic information, a potential benefit of executing each of the plurality of replica adjustment strategies, where the potential benefit includes a potential traffic benefit and a potential storage benefit;
selecting a target replica adjustment strategy from the plurality of replica adjustment strategies based on the potential benefit corresponding to each of the plurality of replica adjustment strategies; and
controlling, based on the target replica adjustment strategy, a deployment of data replicas corresponding to the file directory in the multiple machine rooms.

In a second aspect, the present disclosure provides an apparatus for configuring data replicas for multiple machine rooms, including:
an acquisition module, configured to acquire meta information of a file directory historically accessed by each of multiple machine rooms and historical traffic information for the file directory;
a strategy generation module, configured to generate a plurality of replica adjustment strategies as alternatives based on a deployment of data replicas of the file directory in the multiple machine rooms in the meta information of the file directory;
a prediction module, configured to predict, based on the meta information and the historical traffic information, a potential benefit of executing each of the plurality of replica adjustment strategies, where the potential benefit includes a potential traffic benefit and a potential storage benefit;
a selection module, configured to select a target replica adjustment strategy from the plurality of replica adjustment strategies based on the potential benefit corresponding to each of the plurality of replica adjustment strategies; and
a control module, configured to control, based on the target replica adjustment strategy, a deployment of data replicas corresponding to the file directory in the multiple machine rooms.

In a third aspect, the present disclosure provides a computer-readable medium having a computer program stored thereon, where the computer program, when executed by a processing apparatus, performs the steps of the method according to the first aspect.

In a fourth aspect, the present disclosure provides an electronic device, including:
a storage apparatus, having a computer program stored thereon; and
a processing apparatus, configured to execute the computer program in the storage apparatus to perform the steps of the method according to the first aspect.

In a fifth aspect, the present disclosure provides a computer program product including a computer program, where the computer program, when executed by a processor, performs the steps of the method according to the first aspect.

Other features and advantages of the present disclosure will be described in detail in the following detailed description section.

### BRIEF DESCRIPTION OF DRAWINGS

The above and other features, advantages and aspects of embodiments of the present disclosure will become more apparent when taken in conjunction with the drawings and with reference to the following detailed description. Throughout the drawings, the same or similar reference numerals refer to the same or similar elements. It should be understood that the drawings are schematic and that parts and elements are not necessarily drawn to scale. In the drawings:

FIG. 1 is a flowchart of a method for configuring data replicas for multiple machine rooms according to some embodiments.

FIG. 2 is a schematic structural diagram of an apparatus for configuring data replicas for multiple machine rooms according to an exemplary embodiment.

FIG. 3 is a schematic structural diagram of an electronic device according to an exemplary embodiment.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes and are not intended to limit the scope of protection of the present disclosure.

It should be understood that the various steps described in the method implementations of the present disclosure may be executed in different order and/or in parallel. In addition, the method implementations may include additional steps and/or omit the execution of the illustrated steps. The scope of the present disclosure is not limited in this respect.

As used herein, the term “include/comprise” and its variants are open-ended inclusions, that is, “include/comprise but not limited to”. The term “based on” is “based at least in part on”. The term “one embodiment” represents “at least one embodiment”; the term “another embodiment” represents “at least one additional embodiment”; and the term “some embodiments” represents “at least some embodiments”. Relevant definitions of other terms will be given in the following description.

It should be noted that concepts such as “first” and “second” mentioned in the present disclosure are only used to distinguish different apparatuses, modules or units, and are not used to limit the order or interdependence of functions performed by these apparatuses, modules or units.

It should be noted that the modifiers of “one” and “a plurality of” mentioned in the present disclosure are illustrative and non-restrictive, and those skilled in the art should understand that they should be understood as “one or more” unless the context clearly indicates otherwise.

The names of messages or information exchanged between a plurality of apparatuses in the implementations of the present disclosure are only for illustrative purposes, and are not intended to limit the scope of these messages or information.

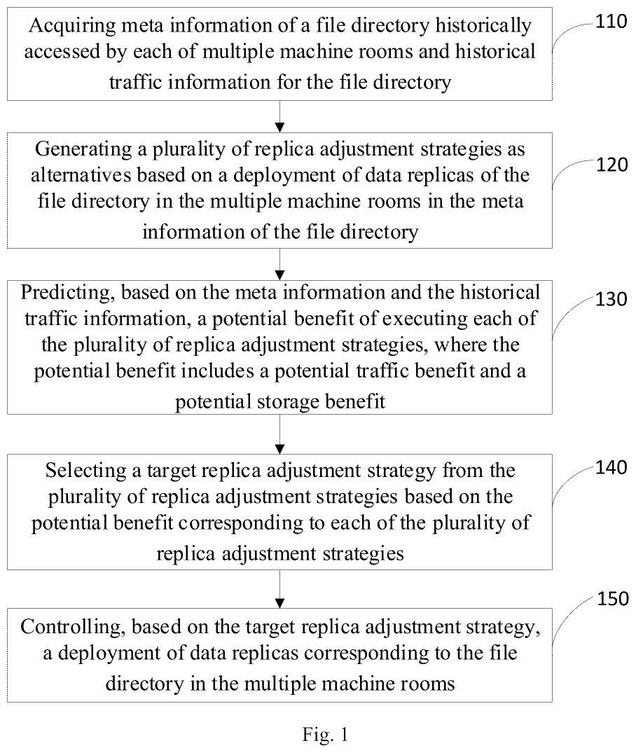

FIG. 1 is a flowchart of a method for configuring data replicas for multiple machine rooms according to some embodiments. As shown in FIG. 1, an embodiment of the present disclosure provides a method for configuring data replicas for multiple machine rooms, and the method may be executed by an electronic device, and specifically may be executed by an apparatus for configuring data replicas for multiple machine rooms. The apparatus may be implemented in software and/or hardware and configured in the electronic device. As shown in FIG. 1, the method may include the following steps.

In step 110, acquiring meta information of a file directory historically accessed by each of multiple machine rooms and historical traffic information for the file directory.

Here, the multiple machine rooms refer to multiple machine rooms in one computer infrastructure. For example, in a distributed file system, the distributed file system has multiple machine rooms distributed in different geographical locations as data centers.

The file directory historically accessed by the machine room refers to a file directory where data required by a computing task in the machine room is historically accessed. Certainly, the file directory may also be understood as an access path of the machine room. The computing task in the machine room accesses the corresponding file directory through the access path to acquire the required data.

The meta information of the file directory may include a size of a file in the file directory, a creation time of the file, and a deployment of data replicas of the file directory in the multiple machine rooms. The data used for subsequent calculation of the potential benefit can be determined through the creation time of the file. The deployment of data replicas of the file directory in the multiple machine rooms may be used to determine a replica adjustment strategy subsequently. For example, distMapᵢ={dcⱼ₁: 1, dcⱼ₂: 2} indicates that the file directory pᵢ has one data replica in the machine room dcⱼ₁ and two data replicas in the machine room dcⱼ₂.

The historical traffic information of the machine room for the file directory may refer to a size of historical access traffic of the computing task in the machine room for each file directory. Exemplarily, the historical traffic information for different historical time periods may be acquired in different manners. For example, for a file directory whose creation date is 30 days ago, the historical traffic information may be directly read from a monitoring log of the machine room, and for a file directory whose creation date is one day ago, the historical traffic information may be calculated from the historical traffic information from 30 days ago. For example, for an access path of /x0/x1/ . . . /x1/date={20540716}/hour=12, the date in the access path may be replaced with a date 30 days ago, such as /x0/x1/ . . . /x1/date={20540616}/hour=12, and then traffic information in the past 30 days is queried to acquire historical traffic information of the access path such as /x0/x1/ . . . /x1/date={20540616}/hour=12 with other machine rooms in the past 30 days, so as to estimate the traffic of the machine room at a future time based on the historical traffic information.

In step 120, generating a plurality of replica adjustment strategies as alternatives based on a deployment of data replicas of the file directory in the multiple machine rooms in the meta information of the file directory.

Here, since the meta information of the file directory includes the deployment of data replicas of the file directory in the multiple machine rooms, for each file directory, the deployment of data replicas of the file directory in the multiple machine rooms may be adjusted according to the deployment of data replicas to generate all possible replica adjustment strategies for the file directory.

The replica adjustment strategy is used to increase or decrease the deployment of data replicas of the file directory in a target machine room of the multiple machine rooms. Increasing the deployment of data replicas of the file directory in the target machine room refers to deploying the data replicas of the file directory in a machine room lacking the data replicas of the file directory. Decreasing the deployment of data replicas of the file directory in the target machine room refers to deleting the data replicas of the file directory in a machine room having the data replicas of the file directory.

It should be understood that the replica adjustment strategy may be different according to different requirements, and the target machine room for which each replica adjustment strategy is specific may be different.

For example, it is assumed that there are machine rooms A, B, and C in the multiple machine rooms, and the meta information represents that the data replicas of a file directory D are deployed in the machine rooms A and B. Then, for the scenario of increasing the deployment of data replicas of the file directory D, an existing replica adjustment strategy includes: increasing the deployment of data replicas of the file directory D in the machine room C. For the scenario of decreasing the deployment of data replicas of the file directory D, an existing replica adjustment strategy includes: decreasing the deployment of data replicas of the file directory D in the machine room A and/or the machine room B.

In step 130, predicting, based on the meta information and the historical traffic information, a potential benefit of executing each of the plurality of replica adjustment strategies, where the potential benefit includes a potential traffic benefit and a potential storage benefit.

Here, the potential benefit refers to an expected benefit brought to the multiple machine rooms when the replica adjustment strategy is executed. The potential benefit includes a storage benefit and a traffic benefit, where the storage benefit represents a storage space that can be reduced in the multiple machine rooms, and the traffic benefit represents a cross-machine room traffic that can be reduced in the multiple machine rooms.

Since the computing task in the machine room will first go to the nearest machine room to acquire data, when the deployment of data replicas corresponding to the file directory is increased in a machine room, the computing task in the machine room changes from originally acquiring the data replica across machine rooms to acquiring the data replica locally in the machine room, which reduces the cross-machine room traffic accordingly, but also increases the use of the storage space. When the deployment of data replicas corresponding to the file directory is decreased in a machine room, the computing task in the machine room changes from originally acquiring the data replica locally in the machine room to acquiring the data replica across machine rooms, which increases the cross-machine room traffic accordingly, but also reduces the use of the storage space.

It should be understood that the values of the potential storage benefit and the potential traffic benefit may be positive or negative. When the values of the potential storage benefit and the potential traffic benefit are positive, it represents that positive potential storage benefit and positive potential traffic benefit can be brought. When the values of the potential storage benefit and the potential traffic benefit are negative, it represents that negative potential storage benefit and negative potential traffic benefit can be brought. For example, when the potential storage benefit is negative, it represents that the storage space will be increased, and when the potential storage benefit is positive, it represents that the storage space will be decreased.

It should be noted that since the data replicas may be distributed in multiple different machine rooms, the machine room where the computing task is located may be different from the machine room where the data required to be read by the computing task is located, and the computing task needs to acquire the required data through cross-machine room communication. Generally, the cost of cross-machine room communication is higher than that of communication in the same machine room. In this case, by increasing the number of the data replicas and reasonably deploying the data replicas in each machine room, the cross-machine room traffic can be significantly saved. However, increasing the number of the data replicas will also increase the storage cost accordingly.

For each generated replica adjustment strategy, the potential storage benefit and the potential traffic benefit brought when the replica adjustment strategy is executed are predicted through the meta information and the historical traffic information, so as to comprehensively measure the potential storage benefit and the potential traffic benefit to determine whether to execute the replica adjustment strategy.

In step 140, selecting a target replica adjustment strategy from the plurality of replica adjustment strategies based on the potential benefit corresponding to each of the plurality of replica adjustment strategies.

Here, after obtaining the potential benefit of each replica adjustment strategy, at least one replica adjustment strategy may be selected from the plurality of alternative replica adjustment strategies, to be used as the target replica adjustment strategy.

It should be noted that when selecting the target replica adjustment strategy according to the potential benefit, the potential storage benefit and the potential traffic benefit corresponding to each replica adjustment strategy may be comprehensively weighed, so that the selected target replica adjustment strategy can reduce more cross-machine room traffic with smaller increase in the storage cost, or increase less cross-machine room traffic with larger reduction of the storage cost.

In step 150, controlling, based on the target replica adjustment strategy, a deployment of data replicas corresponding to the file directory in the multiple machine rooms.

Here, after obtaining the target replica adjustment strategy, the deployment of data replicas of the file directory in the multiple machine rooms may be adjusted through the target replica adjustment strategy. For example, if the target replica adjustment strategy is to increase the deployment of data replicas of the file directory D in the machine room C, one data replica of the file directory D is added in the machine room C.

It should be understood that in the case where the target replica adjustment strategy is to increase the deployment of data replicas of the file directory in the target machine room of the multiple machine rooms, the data replica of the file directory may be deployed in the target machine room by means of temporary buffering. In the case where the target replica adjustment strategy is to decrease the deployment of data replicas of the file directory in the target machine room of the multiple machine rooms, the data replica of the file directory deployed in the target machine room may be reduced in the target machine room by means of EC (Erasure Coding).

It should be noted that the above-mentioned steps 110 to 150 may be periodically executed to timely adjust the deployment of data replicas of the file directory in the multiple machine rooms according to the changes in the multiple machine rooms. For example, the above-mentioned steps 110 to 150 may be executed at least once every day to adjust the deployment of data replicas of the file directory in the multiple machine rooms.

In this way, by acquiring the meta information and the historical traffic information of the file directory, generating the plurality of alternative replica adjustment strategies based on the deployment of data replicas of the file directory in the multiple machine rooms in the meta information of the file directory, predicting, based on the meta information and the historical traffic information, the potential benefit of executing each of the plurality of replica adjustment strategies, selecting the target replica adjustment strategy from the plurality of replica adjustment strategies based on the potential benefit corresponding to each of the plurality of replica adjustment strategies, and controlling, based on the target replica adjustment strategy, the deployment of data replicas corresponding to the file directory in the multiple machine rooms, the potential benefit of the replica adjustment strategy corresponding to each file directory can be accurately calculated, so as to select an optimal target replica adjustment strategy according to the benefit, such that the deployment of data replicas can be optimized.

In some implementable implementations, in step 130, determining, based on historical traffic information of a target machine room for which the replica adjustment strategy is specific, a potential traffic benefit brought by executing the replica adjustment strategy, and determining, based on storage space occupied by the file directory included in the meta information, a potential storage benefit brought by executing the replica adjustment strategy.

Here, the historical traffic information of the target machine room for which the replica adjustment strategy is specific refers to historical traffic information of a computing task in the target machine room specific for a file directory corresponding to the replica adjustment strategy, where the computing task accesses the file directory. For example, there are computing tasks A, B, and C in the target machine room, the computing task A accesses a file directory D to acquire data, the computing task B accesses the file directory D to acquire data, and the computing task C accesses a file directory E to acquire data, then the historical traffic information of the replica adjustment strategy for the file directory D is the historical traffic information of the computing task A and the computing task B for the file directory D.

In some embodiments, in the case where the replica adjustment strategy is to increase the deployment of data replicas of the file directory in at least one target machine room of the multiple machine rooms, the potential traffic benefit brought by executing the replica adjustment strategy may be calculated through a first calculation formula, and the first calculation formula is:

$${saved\_traffic}_{i , lifecycle} = {\sum }_{d = 1}^{lifecycle} {trafficMap}_{i , d} [ d {c}_{t a r g e t} ] ,$$

where lifecycle is a lifecycle of the data replica, saved_traffic_{i,lifecycle} is a potential traffic benefit of an ith file directory within the lifecycle of the data replica, and trafficMap_{i,d}[dc_{target}] is historical traffic information of a target machine room dc_{target} for the ith file directory on a dth day. For example, trafficMap_{i,d}={dcⱼ₁: 100, dcⱼ₂: 200} represents that the file directory pᵢ has 100 GB communication traffic with a computing task in the machine room dcⱼ₁ and 200 GB communication traffic with a computing task in the machine room dcⱼ₂ on the dth day.

For example, it is assumed that data replicas of a file directory pᵢ are distributed in machine rooms dcⱼ₁ and dcⱼ₂, if the replica adjustment strategy is to increase the deployment of one data replica in a target machine room dc_{target}=dc₁₃, the potential traffic benefit brought by executing this replica adjustment strategy is:

$${saved\_traffic}_{i , lifecycle} = {\sum }_{d = 1}^{lifecycle} {trafficMap}_{i , d} [ d {c}_{j 3} ] ,$$

where trafficMap_{i,d}[dcⱼ₃] represents the historical traffic information of the computing task for the corresponding file directory in the target machine room dcⱼ₃.

It should be noted that the lifecycle of the data replica refers to the deployment time of the data replica in the target machine room. For example, the lifecycle of the data replica may be 1-30 days. Certainly, the lifecycle of the data replica may be set according to actual situations.

In some embodiments, in the case where the replica adjustment strategy is to increase the deployment of data replicas of the file directory in at least one target machine room of the multiple machine rooms, the potential storage benefit brought by executing the replica adjustment strategy may be calculated through a second calculation formula, and the second calculation formula is:

$${L}_{i} = {s}_{i} \times lifecycle ,$$

where Lᵢ is a potential storage benefit of the replica adjustment strategy corresponding to the ith file directory, and sᵢ is a size corresponding to the ith file directory.

Certainly, in other implementations, the potential storage benefit brought by executing the replica adjustment strategy may be determined according to the potential traffic benefit corresponding to the replica adjustment strategy and the storage space occupied by the file directory.

Exemplarily, the potential storage benefit brought by executing the replica adjustment strategy may be calculated through a third calculation formula, and the third calculation formula is:

$${ts\_ratio}_{i} = {max}_{1 \leq lifecycle \leq 30} \frac{{saved\_traffic}_{i , lifecycle}}{{s}_{i} \times lifecycle} ,$$

where ts_ratioᵢ is the potential storage benefit of the replica adjustment strategy corresponding to the ith file directory.

It should be noted that ts_ratioᵢ actually represents how much cross-machine room traffic can be saved per day in terms of storage cost, and the larger the value of ts_ratioᵢ, the greater the potential traffic benefit obtained by adding the data replica.

It should be noted that the lifecycle of the added data replica as deployment may also be calculated through the first calculation formula and the second calculation formula. That is, the lifecycle corresponding to the maximum value in the third calculation formula is the lifecycle of the added data replica as deployment.

In some embodiments, in the case where the replica adjustment strategy is to decrease the deployment of data replicas of the file directory in the target machine room of the multiple machine rooms, the potential traffic benefit brought by executing the replica adjustment strategy may be calculated through a fourth calculation formula, and the fourth calculation formula is:

$${total\_traffic}_{i} = {\sum }_{d = 1}^{n} {trafficMap}_{i , d} [ d {c}_{t a r g e t} ] ,$$

where total_trafficᵢ is a potential traffic benefit of the replica adjustment strategy of the ith file directory, n is the total number of days of the historical traffic information, and
trafficMap_{i,d}[dc_{target}] is historical traffic information of the target machine room dc_{target} for the ith file directory on the dth day.

For example, it is assumed that data replicas of a file directory pᵢ are distributed in machine rooms dcⱼ₁ and dcⱼ₂, if the replica adjustment strategy is to reduce the data replica in a target machine room dc_{target}=dcⱼ₁, after the data replica is reduced, traffic of all remaining data replicas will flow to the same machine room, then the potential traffic benefit brought by executing this replica adjustment strategy is:

$${total\_traffic}_{i} = {\sum }_{d = 1}^{n} {trafficMap}_{i , d} [ d {c}_{j 1} ] ,$$

where trafficMap_{i,d}[dcⱼ₁] represents historical traffic information of the computing task for the ith file directory in the target machine room dcⱼ₁ on the dth day.

It should be noted that the total number of days n may be determined according to the acquired historical traffic information. For example, in the embodiment of the present disclosure, the historical traffic information from 30 days ago may be acquired, and accordingly, the total number of days n of the historical traffic information is 30 days.

In some embodiments, in the case where the replica adjustment strategy is to decrease the deployment of data replicas of the file directory in at least one target machine room of the multiple machine rooms, the potential storage benefit brought by executing the replica adjustment strategy may be calculated through a fifth calculation formula, and the fifth calculation formula is:

$${saved\_storage}_{i} = {s}_{i} ,$$

where saved_storageᵢ is a potential storage benefit of the replica adjustment strategy corresponding to the ith file directory, and sᵢ is a size corresponding to the ith file directory.

That is, after one data replica is reduced in deployment, the potential storage benefit as brought is the size of the reduced data replica in deployment.

Through saved_storageᵢ and total_trafficᵢ, the impact on the cross-machine room traffic and the potential storage benefit corresponding to the storage space after the data replica of the replica adjustment strategy corresponding to the ith file directory is removed can be represented.

In this way, through the above implementation, the potential benefit of the replica adjustment strategy can be accurately calculated, and each replica adjustment strategy can be evaluated, thereby providing an accurate data basis for the selection of the replica adjustment strategy.

In some implementable implementations, in step 140, replica adjustment strategies whose potential benefit satisfies a preset condition may be selected from the replica adjustment strategies as candidate replica adjustment strategies, and the target replica adjustment strategy is determined from the candidate replica adjustment strategies according to the potential benefit.

Here, for different types of replica adjustment strategies, the corresponding preset conditions may be different. The preset condition is used to select, from the replica adjustment strategies, replica adjustment strategies whose potential benefit can meet the requirement as the candidate replica adjustment strategies.

For example, in the case where the replica adjustment strategy is to increase the data replica of the file directory in the target machine room of the multiple machine rooms, the preset condition may be: the replica adjustment strategy of saved_traffic_{i,d}<1000 is not considered and/or the replica adjustment strategy of ts_ratioᵢ<10 is not considered. That is, the replica adjustment strategy of saved_{traffic}_{_{i,d}}≥1000 and the replica adjustment strategy of tsᵣₐₜᵢₒ_{ᵢ}≥10 are determined as the candidate replica adjustment strategies.

It should be noted that saved_traffic_{i,d}<1000 may be understood as a small potential traffic benefit achieved by executing the corresponding replica adjustment strategy. The above preset conditions are only some examples, and in practical applications, the preset conditions may also be set according to actual situations.

In the case where the replica adjustment strategy is to decrease the data replica of the file directory in the target machine room of the multiple machine rooms, the preset condition may be: the replica adjustment strategy of total_trafficᵢ>1000 is not considered and/or the replica adjustment strategy of saved_storageᵢ<100 is not considered. That is, the replica adjustment strategy of total_{traffic}_{ᵢ}≤1000 and the replica adjustment strategy of saved_storageᵢ≥100 may be determined as the candidate replica adjustment strategies.

It should be noted that total_trafficᵢ>1000 may be understood as that after the corresponding replica adjustment strategy is executed, a large amount of cross-machine room traffic will be generated by reducing the data replica, and saved_storageᵢ<100 may be understood as a small potential storage benefit brought by executing the corresponding replica adjustment strategy. The above preset conditions are only some examples, and in practical applications, the preset conditions may also be set according to actual situations.

In some embodiments, in the case where the replica adjustment strategy is to decrease the deployment of data replicas of the file directory in at least one target machine room of the multiple machine rooms, replica adjustment strategies whose number of historical accesses of the target machine room for the file directory is not greater than a preset number threshold and whose potential benefit satisfies the preset condition may also be selected from the replica adjustment strategies as the candidate replica adjustment strategies according to the number of historical accesses and the potential benefit.

The number of historical accesses may refer to the number of times the file directory is accessed by the computing task in the machine room. For example, the number of historical accesses may refer to the number of times the file directory is accessed by the computing task in the past 30 days. The number of historical accesses of the target machine room for the file directory refers to the number of times the data replica in the target machine room for which the replica adjustment strategy is specific is accessed by the computing task in other machine rooms.

Exemplarily, the number of historical accesses corresponding to the replica adjustment strategy may be calculated through a sixth calculation formula, and the sixth calculation formula is:

$${total\_access}_{i} = {\sum }_{d = 1}^{n} {access}_{i , d} ,$$

where total_accessᵢ is the number of historical accesses of the replica adjustment strategy corresponding to the ith file directory, and access_{i,d} is the number of historical accesses of the ith file directory on the dth day. For example, access_{i,d}=100 represents that the file directory pᵢ has been accessed 100 times on the dth day.

In the case where the replica adjustment strategy is to decrease the deployment of data replicas of the file directory in at least one target machine room of the multiple machine rooms, the preset condition may be: the replica adjustment strategy of total_trafficᵢ>1000 is not considered and/or the replica adjustment strategy of saved_storageᵢ<100 is not considered and/or the replica adjustment strategy of total_{access}_{ᵢ}>100 is not considered. That is, the replica adjustment strategy of total_{traffic}_{ᵢ}≤1000, the replica adjustment strategy of saved_storageᵢ≥100 and the replica adjustment strategy of total_{access}_{ᵢ}≤100 may be determined as the candidate replica adjustment strategies.

It should be understood that total_{access}_{ᵢ}>100 may be understood as that the data replica reduced by the replica adjustment strategy will be frequently accessed by the computing task, and if the replica adjustment strategy is executed to reduce the deployment of the corresponding data replica, a large amount of cross-machine room traffic will be brought, which increases the communication cost.

In this way, through the above implementations, the replica adjustment strategy can be filtered, and the replica adjustment strategy whose potential benefit does not satisfy the preset condition can be excluded, so as to reduce the subsequent calculation amount and increase the accuracy of the selected target replica adjustment strategy.

In some implementable implementations, in step 140, a target replica adjustment strategy set that satisfies a benefit condition of maximizing a target function may be determined within a given target function and constraint condition based on the potential benefit corresponding to each of the plurality of replica adjustment strategies.

Here, the target replica adjustment strategy set includes at least one replica adjustment strategy. That is, one or more target replica adjustment strategies are selected from all the candidate replica adjustment strategies through the given target function and constraint condition.

The target function is used to maximize the sum of the benefit conditions of the selected target replica adjustment strategy set under the constraint condition. The target function and the constraint condition may comprehensively weigh the potential storage benefit and the potential traffic benefit corresponding to each replica adjustment strategy, so that the selected target replica adjustment strategy can reduce more cross-machine room traffic with smaller increase in the storage cost, or increase less cross-machine room traffic with larger reduction in the storage cost.

Exemplarily, the target function is used to maximize the sum of the potential benefits of the selected target replica adjustment strategy under the constraint condition. For different types of replica adjustment strategies, the corresponding target function and constraint condition may be different. That is, the potential benefit corresponding to the target function may be to maximize the potential traffic benefit or to maximize the potential storage benefit.

In some embodiments, in the case where the replica adjustment strategy is to increase the deployment of data replicas of the file directory in at least one target machine room of the multiple machine rooms, the benefit condition of the target function is the sum of the potential traffic benefits of the replica adjustment strategies included in the target replica adjustment strategy set, and the constraint condition is that the sum of the storage space increased by the replica adjustment strategies included in the target replica adjustment strategy set does not exceed a preset storage capacity.

In the case where the replica adjustment strategy is to increase the deployment of data replicas of the file directory in at least one target machine room of the multiple machine rooms, it is assumed that the potential benefits corresponding to the candidate replica adjustment strategies determined through the above implementations are shown in Table 1.

TABLE 1

| | | | potential traffic | | target machine | |
|---|---|---|---|---|---|---|
| No. | file directory | storage space | benefit | lifecycle | room | ts_ratioᵢ |
| 0 | p₀ | s₀ | trafficMap_{0, 1-3} | lifecycle₀ | dc_{target, 0} | ts_ratio₀ |
| 1 | p₁ | s₁ | trafficMap_{1, 1-3} | lifecycle₁ | dc_{target, 1} | ts_ratio₁ |
| 2 | p₂ | s₂ | trafficMap_{2, 1-3} | lifecycle₂ | dc_{target, 2} | ts_ratio₂ |
| . . . | . . . | . . . | . . . | . . . | . . . | . . . |

Since increasing the deployment of data replicas will increase the storage cost of the multiple machine rooms, it may be constrained that the increase in storage space caused by the increased deployment of data replicas cannot exceed the preset storage capacity. If the preset storage capacity is exceeded, the storage space of the multiple machine rooms may be insufficient due to the increased deployment of data replicas. Therefore, the target replica adjustment strategy may be selected from the replica adjustment strategies for increasing the data replicas of the file directory through the corresponding target function and constraint condition.

The target function may be: max Σᵢ trafficMap_{i,d}[dc_{i,traget}]×xᵢ, and the constraint condition may be: xᵢ ϵ{0,1} and Σᵢ sᵢ×xᵢ≤S, where xᵢ is a decision variable, which is used to represent whether the replica adjustment strategy corresponding to the ith file directory can be used as the target replica adjustment strategy, xᵢ ϵ{0,1} represents that the corresponding replica adjustment strategy will add one data replica, and S is the preset storage capacity.

It should be noted that the constraint condition Σᵢ sᵢ×xᵢ≤S represents that the total amount of storage space increased by all the selected replica adjustment strategies does not exceed the preset storage capacity, and the target function max Σᵢ trafficMap_{i,d}[dc_{i,traget}]×xᵢ is used to maximize the saved cross-machine room traffic.

Through a mathematical programming solution algorithm, the value of xᵢ corresponding to each replica adjustment strategy can be calculated, and the replica adjustment strategy of xᵢ=1 may be determined as the target replica adjustment strategy. For example, at least one replica adjustment strategy may be determined from Table 1 as the target replica adjustment strategy through the target function and the constraint condition.

In some embodiments, in the case where the replica adjustment strategy is to decrease the deployment of data replicas of the file directory in at least one target machine room of the multiple machine rooms, the benefit condition of the target function is the sum of the potential storage benefits of the replica adjustment strategies included in the target replica adjustment strategy set, and the constraint condition is that the sum of the cross-machine room traffic increased by the replica adjustment strategies included in the target replica adjustment strategy set does not exceed a preset traffic threshold.

In the case where the replica adjustment strategy is to decrease the deployment of data replicas of the file directory in the target machine room of the multiple machine rooms, it is assumed that the potential benefits corresponding to the candidate replica adjustment strategies determined through the above implementations are shown in Table 2.

TABLE 2

| | | machine rooms where | potential | | number of |
|---|---|---|---|---|---|
| | file | remaining data | storage | increased cross- | historical |
| No. | directory | replicas are located | benefits | machine traffic | accesses |
| 0 | p₀ | dc_{target, 0} | s₀ | total_traffic₀ | total_access₀ |
| 1 | p₁ | dc_{target, 1} | s₁ | total_traffic₁ | total_access₁ |
| 2 | p₂ | dc_{target, 2} | s₂ | total_traffic₂ | total_access₁ |
| . . . | . . . | . . . | . . . | . . . | . . . |

Since decreasing the deployment of data replicas will increase the cross-machine room traffic in the multiple machine rooms, which results in an increase in the bandwidth policy cost, it may be constrained that the increase in cross-machine room traffic caused by the reduced data replicas cannot exceed the preset traffic threshold. If the preset traffic threshold is exceeded, the multiple machine rooms may be brought with bandwidth pressure due to the reduced deployment of data replicas. Therefore, the target replica adjustment strategy may be selected from the replica adjustment strategies for decreasing the data replicas of the file directory through the corresponding target function and constraint condition.

The target function may be: max Σᵢ(xᵢ×sᵢ), and the constraint condition may be: Σᵢ(xᵢ×total_trafficᵢ)≤T, where xᵢ is a decision variable, which is used to represent whether the replica adjustment strategy corresponding to the ith file directory can be used as the target replica adjustment strategy, and T is the preset traffic threshold.

It should be noted that the constraint condition Σᵢ(xᵢ×total_trafficᵢ)≤T is used to limit the increase in cross-machine room traffic caused by the reduction in the deployment of data replicas not to exceed the preset traffic threshold, and max Σᵢ(xᵢ×sᵢ) is used to maximize the storage space saved by reducing the deployment of data replicas.

Through the mathematical programming solution algorithm, the value of xᵢ corresponding to each replica adjustment strategy can be calculated, and the replica adjustment strategy of xᵢ=1 may be determined as the target replica adjustment strategy. For example, at least one candidate replica adjustment strategy may be determined from Table 2 as the target replica adjustment strategy through the target function and the constraint condition.

In this way, through the above implementations, the cost increased in the replica adjustment process can be controlled through the target function and the constraint condition, and the benefit brought by the replica adjustment can be maximized at the same time, thereby realizing double optimization of storage cost and bandwidth cost.

In some implementable implementations, in step 150, the plurality of target replica adjustment strategies may be sorted in a descending order of the potential benefit to obtain sorted target replica adjustment strategies, and the deployment of data replicas of the corresponding file directory in the multiple machine rooms is controlled in sequence based on the sorted target replica adjustment strategies.

Here, after determining the target replica adjustment strategy set including the plurality of replica adjustment strategies from the replica adjustment strategies, due to possible changes in the multiple machine rooms, not all the target replica adjustment strategies included in the target replica adjustment strategy set can be executed. Therefore, all the target replica adjustment strategies included in the target replica adjustment strategy set may be sorted to obtain sorted target replica adjustment strategies, and the target replica adjustment strategies are executed in sequence according to the sorted target replica adjustment strategies, so as to adjust the deployment of data replicas of the corresponding file directory in the multiple machine rooms.

In the case where the replica adjustment strategy is to increase the deployment of data replicas of the file directory in the target machine room of the multiple machine rooms, the selected target replica adjustment strategies may be sorted in the descending order of the potential storage benefit. For example, the selected target replica adjustment strategies may be sorted in the descending order of ts_ratioᵢ to give priority to the target replica adjustment strategy with the largest potential storage benefit.

In the case where the replica adjustment strategy is to decrease the deployment of data replicas of the file directory in the target machine room of the multiple machine rooms, the selected target replica adjustment strategies may be sorted in the descending order of the potential storage benefit. For example, the selected target replica adjustment strategies may be sorted in the descending order of sᵢ to give priority to the target replica adjustment strategy with the largest potential storage benefit.

In this way, through the above implementations, the target replica adjustment strategy with the largest benefit can be executed first to ensure that the largest benefit can be obtained in the case where not all the target replica adjustment strategies can be completely executed. For example, it is assumed that 10 target replica adjustment strategies are selected from 100 replica adjustment strategies. When the target replica adjustment strategies are executed, due to the changes in the multiple machine rooms, it may be impossible to execute other target replica adjustment strategies after some target replica adjustment strategies are executed. Through the sorting in the descending order of the potential benefit, it can be ensured that the target replica adjustment strategy with the largest benefit is executed first.

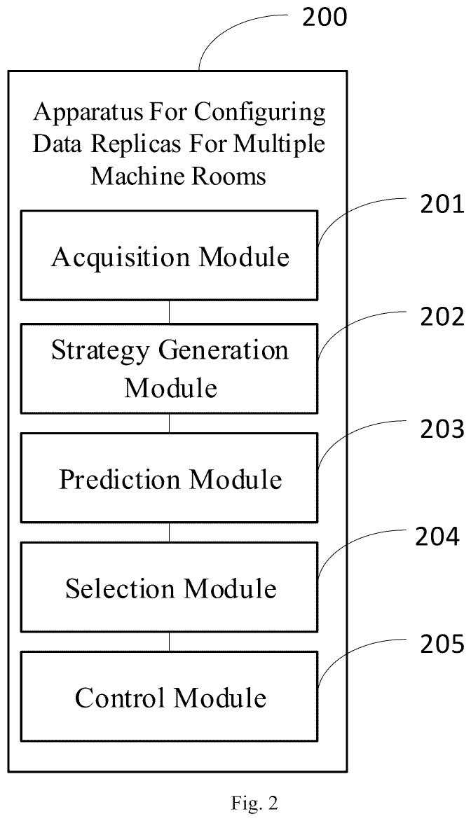

FIG. 2 is a schematic structural diagram of an apparatus for configuring data replicas for multiple machine rooms according to an exemplary embodiment. As shown in FIG. 2, an embodiment of the present disclosure provides an apparatus for configuring data replicas for multiple machine rooms 200, and the apparatus for configuring data replicas for multiple machine rooms 200 includes:
an acquisition module 201, configured to acquire meta information of a file directory historically accessed by each of multiple machine rooms and historical traffic information for the file directory;
a strategy generation module 202, configured to generate a plurality of replica adjustment strategies as alternatives based on a deployment of data replicas of the file directory in the multiple machine rooms in the meta information of the file directory;
a prediction module 203, configured to predict, based on the meta information and the historical traffic information, a potential benefit of executing each of the plurality of replica adjustment strategies, where the potential benefit includes a potential traffic benefit and a potential storage benefit;
a selection module 204, configured to select a target replica adjustment strategy from the plurality of replica adjustment strategies based on the potential benefit corresponding to each of the plurality of replica adjustment strategies; and
a control module 205, configured to control, based on the target replica adjustment strategy, a deployment of data replicas corresponding to the file directory in the multiple machine rooms.

Optionally, the selection module 204 is further configured to:
determine, within a given target function and constraint condition, a target replica adjustment strategy set that satisfies a benefit condition of maximizing the target function based on the potential benefit corresponding to each of the plurality of replica adjustment strategies, where the target replica adjustment strategy set includes at least one replica adjustment strategy.

Optionally, in the case where the replica adjustment strategy is to increase the deployment of data replicas of the file directory in at least one target machine room of the multiple machine rooms, the benefit condition of the target function is the sum of the potential traffic benefits of the replica adjustment strategies included in the target replica adjustment strategy set, and the constraint condition is that the sum of the storage space increased by the replica adjustment strategies included in the target replica adjustment strategy set does not exceed a preset storage capacity;
in the case where the replica adjustment strategy is to decrease the deployment of data replicas of the file directory in at least one target machine room of the multiple machine rooms, the benefit condition of the target function is the sum of the potential storage benefits of the replica adjustment strategies included in the target replica adjustment strategy set, and the constraint condition is that the sum of the cross-machine room traffic increased by the replica adjustment strategies included in the target replica adjustment strategy set does not exceed a preset traffic threshold.

Optionally, the prediction module 203 is further configured to:
determine, based on historical traffic information of a target machine room for which the replica adjustment strategy is specific, the potential traffic benefit brought by executing the replica adjustment strategy; and
determine, based on storage space occupied by the file directory included in the meta information, the potential storage benefit brought by executing the replica adjustment strategy.

Optionally, the prediction module 203 is further configured to:
in the case where the replica adjustment strategy is to increase the deployment of data replicas of the file directory in at least one target machine room of the multiple machine rooms, determine the potential storage benefit brought by executing the replica adjustment strategy according to the potential traffic benefit corresponding to the replica adjustment strategy and the storage space occupied by the file directory.

Optionally, the selection module 204 is further configured to:
select, from the replica adjustment strategies, replica adjustment strategies whose potential benefit satisfies a preset condition as candidate replica adjustment strategies; and
select the target replica adjustment strategy from the candidate replica adjustment strategies according to the potential benefit.

Optionally, the selection module 204 is further configured to:
in the case where the replica adjustment strategy is to decrease the deployment of data replicas of the file directory in at least one target machine room of the multiple machine rooms, select, from the replica adjustment strategies, replica adjustment strategies whose number of historical accesses of the target machine room for the file directory is not greater than a preset number threshold and whose potential benefit satisfies the preset condition as the candidate replica adjustment strategies according to the number of historical accesses and the potential benefit.

Optionally, the control module 205 is further configured to:
sort a plurality of target replica adjustment strategies in a descending order of the potential benefit to obtain sorted target replica adjustment strategies; and
control the deployment of data replicas of the corresponding file directory in the multiple machine rooms in sequence based on the sorted target replica adjustment strategies.

For the logic of the method executed by the above-mentioned various functional modules in the apparatus for configuring data replicas for multiple machine rooms 200, reference may be made to the part related to the method in the above-mentioned embodiments, which will not be repeated here.

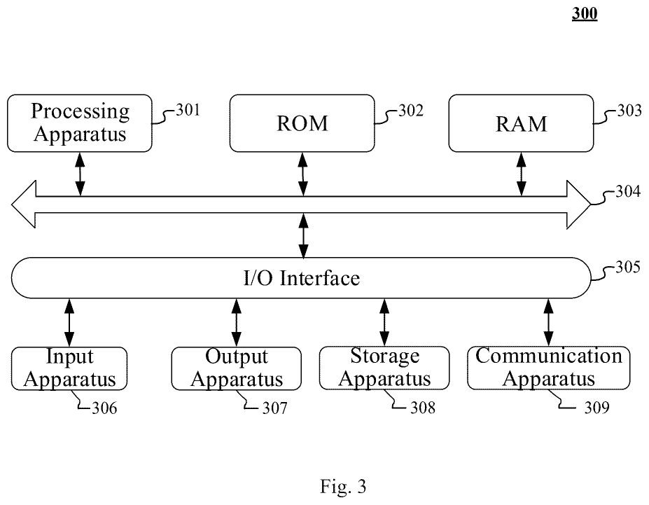

Reference is made to FIG. 3 below, which illustrates a schematic structural diagram of an electronic device (such as a terminal device or a server) 300 suitable for implementing the embodiments of the present disclosure. The terminal device in the embodiments of the present disclosure may include, but is not limited to, a mobile terminal such as a mobile phone, a notebook computer, a digital broadcast receiver, a PDA (personal digital assistant), a tablet computer, a portable multimedia player (PMP), a vehicle-mounted terminal (such as a vehicle-mounted navigation terminal), etc., and a fixed terminal such as a digital TV, a desktop computer, etc. The electronic device shown in FIG. 3 is only an example, and should not impose any limitation on the function and scope of use of the embodiments of the present disclosure.

As shown in FIG. 3, the electronic device 300 may include a processing apparatus (such as a central processing unit, a graphics processor, etc.) 301, which may perform various appropriate actions and processing according to a program stored in a read-only memory (ROM) 302 or a program loaded from a storage apparatus 308 into a random-access memory (RAM) 303. The RAM 303 also stores various programs and data required for the operation of the electronic device 300. The processing apparatus 301, the ROM 302, and the RAM 303 are connected to each other through a bus 304. An input/output (I/O) interface 305 is also connected to the bus 304.

Generally, the following apparatuses may be connected to the I/O interface 305: an input apparatus 306 including, for example, a touchscreen, a touchpad, a keyboard, a mouse, a camera, a microphone, an accelerometer, a gyroscope, etc.; an output apparatus 307 including, for example, a liquid crystal display (LCD), a speaker, a vibrator, etc.; a storage apparatus 308 including, for example, a magnetic tape, a hard disk, etc.; and a communication apparatus 309. The communication apparatus 309 may allow the electronic device 300 to perform wireless or wired communication with other devices to exchange data. Although FIG. 3 shows the electronic device 300 having various apparatuses, it should be understood that not all of the illustrated apparatuses are necessarily implemented or provided. More or fewer apparatuses may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, where the computer program includes program codes for executing the method shown in the flowcharts. In such an embodiment, the computer program may be downloaded and installed from a network through the communication apparatus 309, or installed from the storage apparatus 308, or installed from the ROM 302. When the computer program is executed by the processing apparatus 301, the above-mentioned functions defined in the methods of the embodiments of the present disclosure are performed.

It should be noted that the above-mentioned computer-readable medium in the present disclosure may be a computer-readable signal medium, a computer-readable storage medium, or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that can be used by or in combination with an instruction execution system, apparatus or device. In the present disclosure, the computer-readable signal medium may include a data signal propagated in a baseband or as a part of a carrier wave, where computer-readable program codes are carried in the data signal. The data signal propagated in this manner may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus or device. The program codes contained on the computer-readable medium may be transmitted by any suitable medium, including but not limited to a wire, an optical cable, a radio frequency (RF), etc., or any suitable combination thereof.

In some implementations, the electronic device and each of the machine rooms may communicate using any currently known or future developed network protocol such as HTTP (Hypertext transfer protocol), and may be interconnected with digital data communication (e.g., communication network) in any form or medium. Examples of the communication network include a local area network (“LAN”), a wide area network (“WAN”), an internet (e.g., the Internet), and an end-to-end network (e.g., an ad hoc end-to-end network), as well as any currently known or future developed network.

The above-mentioned computer-readable medium may be included in the above-mentioned electronic device; or may exist alone without being assembled into the electronic device.

The above-mentioned computer-readable medium carries one or more programs, and when the one or more programs are executed by the electronic device, the electronic device is caused to: acquire meta information of a file directory historically accessed by each of multiple machine rooms and historical traffic information for the file directory; generate a plurality of replica adjustment strategies as alternatives based on a deployment of data replicas of the file directory in the multiple machine rooms in the meta information of the file directory; predict, based on the meta information and the historical traffic information, a potential benefit of executing each of the plurality of replica adjustment strategies, where the potential benefit includes a potential traffic benefit and a potential storage benefit; select a target replica adjustment strategy from the plurality of replica adjustment strategies based on the potential benefit corresponding to each of the plurality of replica adjustment strategies; and control, based on the target replica adjustment strategy, a deployment of data replicas corresponding to the file directory in the multiple machine rooms.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as C or similar programming languages. The program codes may be executed entirely on a user's computer, partly on a user's computer, as a stand-alone software package, partly on a user's computer and partly on a remote computer, or entirely on a remote computer or a server. In the case of involving the remote computer, the remote computer may be connected to the user's computer through any kind of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by special-purpose hardware-based systems that perform the specified functions or operations, or combinations of special-purpose hardware and computer instructions.

The modules involved in the embodiments described in the present disclosure may be implemented in software or hardware. Among them, the name of the module does not constitute a limitation of the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with an instruction execution system, apparatus or device. The machine-readable medium may be a machine-readable signal medium or a machine-readable storage medium. The machine-readable medium may include but is not limited to an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description is only preferred embodiments of the present disclosure and illustrations of the applied technical principles. Those skilled in the art should understand that the scope of disclosure involved in the present disclosure is not limited to the technical solutions formed by the specific combination of the above-mentioned technical features, but also covers other technical solutions formed by any combination of the above-mentioned technical features or their equivalent features without departing from the above-mentioned disclosed concept. For example, the technical solution formed by replacing the above-mentioned features with the technical features having similar functions disclosed in the present disclosure (but not limited to).

In addition, although operations are depicted in a particular order, this should not be understood as requiring these operations to be performed in a particular order shown or in a sequential order. Under certain circumstances, multitasking and parallel processing may be advantageous. Similarly, although the above discussion includes several specific implementation details, these should not be construed as limitations on the scope of the present disclosure. Certain features that are described in the context of separate embodiments may also be implemented in combination in a single embodiment. On the contrary, various features described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are merely exemplary forms for implementing the claims. Regarding the apparatus in the above embodiments, the specific manner in which each module performs operations has been described in detail in the embodiments related to the method, and will not be described in detail here.

1. A method for configuring data replicas for multiple machine rooms, comprising:
acquiring meta information of a file directory historically accessed by each of multiple machine rooms and historical traffic information for the file directory;
generating a plurality of replica adjustment strategies as alternatives based on a deployment of data replicas of the file directory in the multiple machine rooms in the meta information of the file directory;
predicting, based on the meta information and the historical traffic information, a potential benefit of executing each of the plurality of replica adjustment strategies, wherein the potential benefit comprises a potential traffic benefit and a potential storage benefit;
selecting a target replica adjustment strategy from the plurality of replica adjustment strategies based on the potential benefit corresponding to each of the plurality of replica adjustment strategies; and
controlling, based on the target replica adjustment strategy, a deployment of data replicas corresponding to the file directory in the multiple machine rooms.

2. The method according to claim 1, wherein the selecting a target replica adjustment strategy from the plurality of replica adjustment strategies based on the potential benefit corresponding to each of the plurality of replica adjustment strategies comprises:
determining, within a given target function and a constraint condition, a target replica adjustment strategy set that satisfies a benefit condition of maximizing the target function, based on the potential benefit corresponding to each of the plurality of replica adjustment strategies, wherein the target replica adjustment strategy set comprises at least one replica adjustment strategy.

3. The method according to claim 2, wherein
in response to that the replica adjustment strategy is to increase a deployment of data replicas of the file directory in at least one target machine room of the multiple machine rooms, the benefit condition of the target function is a sum of potential traffic benefits of the replica adjustment strategies comprised in the target replica adjustment strategy set, and the constraint condition is that a sum of storage space increased by the replica adjustment strategies comprised in the target replica adjustment strategy set does not exceed a preset storage capacity; and
in response to that the replica adjustment strategy is to decrease a deployment of data replicas of the file directory in at least one target machine room of the multiple machine rooms, the benefit condition of the target function is a sum of potential storage benefits of the replica adjustment strategies comprised in the target replica adjustment strategy set, and the constraint condition is that a sum of cross-machine room traffic increased by the replica adjustment strategies comprised in the target replica adjustment strategy set does not exceed a preset traffic threshold.

4. The method according to claim 1, wherein the predicting, based on the meta information and the historical traffic information, a potential benefit of executing each of the plurality of replica adjustment strategies comprises:
determining, based on historical traffic information of a target machine room for which the replica adjustment strategy is specific, the potential traffic benefit brought by executing the replica adjustment strategy; and
determining, based on storage space occupied by the file directory comprised in the meta information, the potential storage benefit brought by executing the replica adjustment strategy.

5. The method according to claim 4, wherein the determining, based on storage space occupied by the file directory comprised in the meta information, the potential storage benefit brought by executing the replica adjustment strategy comprises:
in response to that the replica adjustment strategy is to increase a deployment of data replicas of the file directory in at least one target machine room of the multiple machine rooms, determining the potential storage benefit brought by executing the replica adjustment strategy according to the potential traffic benefit corresponding to the replica adjustment strategy and the storage space occupied by the file directory.

6. The method according to claim 1, wherein the selecting a target replica adjustment strategy from the plurality of replica adjustment strategies based on the potential benefit corresponding to each of the plurality of replica adjustment strategies comprises:
selecting, from the plurality of replica adjustment strategies, replica adjustment strategies whose potential benefits satisfy a preset condition as candidate replica adjustment strategies; and
selecting the target replica adjustment strategy from the candidate replica adjustment strategies according to the potential benefit.

7. The method according to claim 6, wherein the selecting, from the plurality of replica adjustment strategies, replica adjustment strategies whose potential benefits satisfy a preset condition as candidate replica adjustment strategies comprises:
in response to that the replica adjustment strategy is to decrease a deployment of data replicas of the file directory in at least one target machine room of the multiple machine rooms, selecting, from the plurality of replica adjustment strategies, replica adjustment strategies whose number of historical accesses of the target machine room for the file directory is not greater than a preset number threshold and whose potential benefits satisfy the preset condition as the candidate replica adjustment strategies according to the number of historical accesses and the potential benefit.

8. The method according to claim 1, wherein the controlling, based on the target replica adjustment strategy, a deployment of data replicas corresponding to the file directory in the multiple machine rooms comprises:
sorting a plurality of target replica adjustment strategies in a descending order of the potential benefit to obtain sorted target replica adjustment strategies; and
controlling the deployment of data replicas of the corresponding file directory in the multiple machine rooms sequentially based on the sorted target replica adjustment strategies.

9. A non-transitory computer-readable medium having a computer program stored thereon, wherein the computer program, when executed by a processing apparatus, is configured to cause the processing apparatus to perform a method for configuring data replicas for multiple machine rooms, comprising:
acquiring meta information of a file directory historically accessed by each of multiple machine rooms and historical traffic information for the file directory;
generating a plurality of replica adjustment strategies as alternatives based on a deployment of data replicas of the file directory in the multiple machine rooms in the meta information of the file directory;
predicting, based on the meta information and the historical traffic information, a potential benefit of executing each of the plurality of replica adjustment strategies, wherein the potential benefit comprises a potential traffic benefit and a potential storage benefit;
selecting a target replica adjustment strategy from the plurality of replica adjustment strategies based on the potential benefit corresponding to each of the plurality of replica adjustment strategies; and
controlling, based on the target replica adjustment strategy, a deployment of data replicas corresponding to the file directory in the multiple machine rooms.

10. The medium according to claim 9, wherein the selecting a target replica adjustment strategy from the plurality of replica adjustment strategies based on the potential benefit corresponding to each of the plurality of replica adjustment strategies comprises:
determining, within a given target function and a constraint condition, a target replica adjustment strategy set that satisfies a benefit condition of maximizing the target function, based on the potential benefit corresponding to each of the plurality of replica adjustment strategies, wherein the target replica adjustment strategy set comprises at least one replica adjustment strategy.

11. The medium according to claim 10, wherein,
in response to that the replica adjustment strategy is to increase a deployment of data replicas of the file directory in at least one target machine room of the multiple machine rooms, the benefit condition of the target function is a sum of potential traffic benefits of the replica adjustment strategies comprised in the target replica adjustment strategy set, and the constraint condition is that a sum of storage space increased by the replica adjustment strategies comprised in the target replica adjustment strategy set does not exceed a preset storage capacity; and
in response to that the replica adjustment strategy is to decrease a deployment of data replicas of the file directory in at least one target machine room of the multiple machine rooms, the benefit condition of the target function is a sum of potential storage benefits of the replica adjustment strategies comprised in the target replica adjustment strategy set, and the constraint condition is that a sum of cross-machine room traffic increased by the replica adjustment strategies comprised in the target replica adjustment strategy set does not exceed a preset traffic threshold.

12. The medium according to claim 9, wherein the predicting, based on the meta information and the historical traffic information, a potential benefit of executing each of the plurality of replica adjustment strategies comprises:
determining, based on historical traffic information of a target machine room for which the replica adjustment strategy is specific, the potential traffic benefit brought by executing the replica adjustment strategy; and
determining, based on storage space occupied by the file directory comprised in the meta information, the potential storage benefit brought by executing the replica adjustment strategy.

13. The medium according to claim 12, wherein the determining, based on storage space occupied by the file directory comprised in the meta information, the potential storage benefit brought by executing the replica adjustment strategy comprises:
in response to that the replica adjustment strategy is to increase a deployment of data replicas of the file directory in at least one target machine room of the multiple machine rooms, determining the potential storage benefit brought by executing the replica adjustment strategy according to the potential traffic benefit corresponding to the replica adjustment strategy and the storage space occupied by the file directory.

14. The medium according to claim 9, wherein the selecting a target replica adjustment strategy from the plurality of replica adjustment strategies based on the potential benefit corresponding to each of the plurality of replica adjustment strategies comprises:
selecting, from the plurality of replica adjustment strategies, replica adjustment strategies whose potential benefits satisfy a preset condition as candidate replica adjustment strategies; and
selecting the target replica adjustment strategy from the candidate replica adjustment strategies according to the potential benefit.

15. The medium according to claim 14, wherein the selecting, from the plurality of replica adjustment strategies, replica adjustment strategies whose potential benefits satisfy a preset condition as candidate replica adjustment strategies comprises:
in response to that the replica adjustment strategy is to decrease a deployment of data replicas of the file directory in at least one target machine room of the multiple machine rooms, selecting, from the plurality of replica adjustment strategies, replica adjustment strategies whose number of historical accesses of the target machine room for the file directory is not greater than a preset number threshold and whose potential benefits satisfy the preset condition as the candidate replica adjustment strategies according to the number of historical accesses and the potential benefit.

16. The medium according to claim 9, wherein the controlling, based on the target replica adjustment strategy, a deployment of data replicas corresponding to the file directory in the multiple machine rooms comprises:
sorting a plurality of target replica adjustment strategies in a descending order of the potential benefit to obtain sorted target replica adjustment strategies; and
controlling the deployment of data replicas of the corresponding file directory in the multiple machine rooms sequentially based on the sorted target replica adjustment strategies.

17. An electronic device, comprising:
a storage apparatus having a computer program stored thereon; and
a processing apparatus configured to execute the computer program in the storage apparatus to implement a method for configuring data replicas for multiple machine rooms, the method comprising:
acquiring meta information of a file directory historically accessed by each of multiple machine rooms and historical traffic information for the file directory;
generating a plurality of replica adjustment strategies as alternatives based on a deployment of data replicas of the file directory in the multiple machine rooms in the meta information of the file directory;
predicting, based on the meta information and the historical traffic information, a potential benefit of executing each of the plurality of replica adjustment strategies, wherein the potential benefit comprises a potential traffic benefit and a potential storage benefit;
selecting a target replica adjustment strategy from the plurality of replica adjustment strategies based on the potential benefit corresponding to each of the plurality of replica adjustment strategies; and
controlling, based on the target replica adjustment strategy, a deployment of data replicas corresponding to the file directory in the multiple machine rooms.

18. The electronic device according to claim 17, wherein the selecting a target replica adjustment strategy from the plurality of replica adjustment strategies based on the potential benefit corresponding to each of the plurality of replica adjustment strategies comprises:
determining, within a given target function and a constraint condition, a target replica adjustment strategy set that satisfies a benefit condition of maximizing the target function, based on the potential benefit corresponding to each of the plurality of replica adjustment strategies, wherein the target replica adjustment strategy set comprises at least one replica adjustment strategy.

19. The electronic device according to claim 18, wherein
in response to that the replica adjustment strategy is to increase a deployment of data replicas of the file directory in at least one target machine room of the multiple machine rooms, the benefit condition of the target function is a sum of potential traffic benefits of the replica adjustment strategies comprised in the target replica adjustment strategy set, and the constraint condition is that a sum of storage space increased by the replica adjustment strategies comprised in the target replica adjustment strategy set does not exceed a preset storage capacity; and
in response to that the replica adjustment strategy is to decrease a deployment of data replicas of the file directory in at least one target machine room of the multiple machine rooms, the benefit condition of the target function is a sum of potential storage benefits of the replica adjustment strategies comprised in the target replica adjustment strategy set, and the constraint condition is that a sum of cross-machine room traffic increased by the replica adjustment strategies comprised in the target replica adjustment strategy set does not exceed a preset traffic threshold.

20. The electronic device according to claim 17, wherein the predicting, based on the meta information and the historical traffic information, a potential benefit of executing each of the plurality of replica adjustment strategies comprises:
determining, based on historical traffic information of a target machine room for which the replica adjustment strategy is specific, the potential traffic benefit brought by executing the replica adjustment strategy; and
determining, based on storage space occupied by the file directory comprised in the meta information, the potential storage benefit brought by executing the replica adjustment strategy.
